(19) United States
(12) Patent Application Publication
(10) Pub. No.: US 2012/0057707 A1
(43) Pub. Date: Mar. 8, 2012

(54) METHOD OF ABOLISHING UNAUTHORIZED COPYING OF DIGITAL DATA STORED ON AN OPTICAL DISC

(76) Inventor: Ko Cheng FANG, New Taipei (TW)

(21) Appl. No.: 13/222,300

(22) Filed: Aug. 31, 2011

(30) Foreign Application Priority Data
Sep. 3, 2010 (TW) 99129808

(51) Int. Cl. H04L 9/00; G11B 19/04

(52) U.S. Cl. 380/277; 369/53.21; G9B/19.005

(57) ABSTRACT

A method of abolishing unauthorized copying of digital data stored on an optical disc includes the steps of distributing overwrite modules of a copy protection module into a data file that is to be protected against illegal copying, so as to form a copy-protected data file; and writing the copy-protected data file into a non-rewriteable optical storage media. The overwrite modules are respectively located between any two adjacent data blocks of the data file, such that each data block and a following overwrite module together form a group and the copy-protected data file includes a plurality of sequentially arranged groups of data block and overwrite module. With the overwrite modules, data blocks read out by a readout device are repeatedly overwritten by subsequent data blocks in a specified register, so that no data file from the optical storage media will be stored in the specified register and be illegally copied or pirated.

### FIELD OF THE INVENTION

The present invention relates to a method of abolishing unauthorized copying of digital data stored on an optical disc, and more specifically is a method of abolishing unauthorized copying of digital data stored on an optical disc by adding an overwrite modules into the digital data to be protected, so when the digital data stored onto an optical disc is read into a register, such as a memory, of a readout device is overwritten and erased from the register.

### BACKGROUND OF THE INVENTION

Due to the prosperous development of computer products in recent years, various multifunctional optical discs, such as compact discs (CDs), Video Compact Discs (VCD), Super Video Compact Discs (SVCD), Digital Video Disc (DVD) and alike which provide huge storage capacity and are available at low price, have become very popular among the general public. However, those who have ordinary computer-related skill or knowledge can easily crack and pirate the data content in these digital media and mass-replicate the data content for resale purpose. Therefore, the presence of pirated CDs, VCDs, SVCDs, DVDs and alike in the market is a very serious problem nowadays.

In a current time having so many replicating techniques and software available, the development of various copy-abolishing and anti-piracy techniques has become another prerequisite means other than the general intellectual property related laws for protecting inventors' rights.

For example, SONY had developed an AACS (Advanced Access Content System) copy-protection system in 2007 in its attempt to provide a useful copy protection technique. However, the Sony-developed AACS copy-protection system was cracked soon after its implementation into the market. This fact clearly manifest the challenges faced by the copy protection techniques currently available.

AACS is a copy protection technique developed for Blu-ray CD. In a Blu-ray CD with AACS copy protection, which included a media key block, a volume key, an encrypted title key, and an encrypted content. And, all the players for playing Blu-ray discs, either software or hardware, shall include AACS-authorized device key and sequence key.

When using a CD with AACS copy protection, the CD will first check the device key for its authenticity. If the device key is found as legitimate and not shown on the blacklist, a series of decryption procedures as below will start:
(1) Reading out the media key from the media key block and decrypting the media key along with the sequence key to obtain a procedure key;
(2) Using an AES-G decryption algorithm to decrypt the procedure key and the volume key, which is copy-protected and must be read out in a specific way, so as to obtain a volume unique key;
(3) Reading out the encrypted title key from the CD, and decrypting the encrypted title key using the volume unique key to obtain a title key; and
(4) Using the title key to decrypt the encrypted content into a readable media content file.

The main protection mechanism in the above AACS copy protection technique is the use of a specific volume key to prevent the media from being purposefully copied. The volume key is recorded onto the Blu-ray disc using a special device and could not be read or copied using common recording methods.

Yet, the AACS copy protection technique available in the market is cracked as well. Generally, when running a data file stored in a CD, the data file is first read into a register in a memory for decoding the data file. While the register would generally erase the data previously held temporarily therein, the data is not really erased to an extent sufficient to abolish copying of it. A hacker can still locate the volume key directly from the register of the memory. Once the volume key is located from the memory, the hacker can easily copy the volume key and freely distribute all the data contents stored on the Blu-ray disc.

To enhance the AACS copy protection technique, SONY develops another AACS LA copy protection scheme as a means to prevent cracking by hackers. According to the AACS LA copy protection scheme, any device key on a cracked CD device or software program is detected and added in a blacklist; and any player, either software or hardware, having a device key that is in the blacklist can no longer read in any data from a Blu-ray disc issued later than the cracked Blu-ray disc. However, the implementation of the AACS LA copy protection scheme necessitates the collection of users' personal information, which tends to cause disputes on users' privacy.

From the above observation, it can be seen that all the currently available digital data copy protection mechanisms fail to provide a simple copy protection that does not need to collect users' personal information. Therefore, it is obviously necessary to further develop new and improved method for abolishing unauthorized copying of digital data stored on an optical disc.

### SUMMARY OF THE INVENTION

A primary objective of the present invention is to provide a method of abolishing unauthorized copying of digital data stroed on an optical disc by erasing and accordingly deleting data files temporarily held in a specified register of a readout device, so that there is no way for any bad faith user to illegally copy or pirate the digital data stored on an optical disc via the register of the readout device, thus the inventor's or an author's intellectual property can be effectively protected.

Another objective of the present invention is to provide a method of abolishing a bad faith user from illegally copying digital data stored on an optical disc by making the digital data file being copied to become an error file or become an enormous replicated data file that the output divice can never accommodate, so that the bad faith user can only get useless data files from the error files or fails to copy any of the exponentially inflated data file. Effectively, an inventor's intellectual property can be protected.

A further objective of the present invention is to provide a method of abolishing unauthorized copying of digital data stored on an optical disc by using an encryption algorithm to further encrypt or re-compile a copy-protected data file in an optical storage media, so that we can enhance the effectiveness of abolishing unauthorized copying of digital data on an optical disc through combination of multiple copy-protection and anti-piracy techniques.

To achieve the above and other objectivess, the method of abolishing unauthorized copying of digital data on an optical disc according to a first preferred embodiment of the present invention includes the steps of distributing a plurality of overwrite modules of a copy protection module into a data file that is to be protected against unauthorized copying, so as to form a copy-protected data file; and writing the copy-protected data file into a non-rewriteable optical storage media. The overwrite modules of the copy protection module distributed into the data file are respectively arranged between any two adjacent data blocks of the data file, such that each data block and a following overwrite module together form a group and the copy-protected data file so formed includes a plurality of sequentially arranged first, second, third and more groups of data block and overwrite module.

When a user requests a readout device to read out the copy-protected data file stored on the optical storage media, the readout device first reads the data block of the copy-protected data file in the first group into a specified register in the readout device for decoding, and then reads the overwrite module in the first group, which requests the readout device to read the data block in the second group into the same specified register to thereby cover the first data block previously read into the specified register. The readout device repeats the reading procedure so that the data blocks in the subsequent groups are sequentially read into the specified register one by one while cover the preceding data blocks being temporarily held in the specified register. Therefore, no data of the copy-protected data file will be stored in the specified register of the readout device.

Further, according to the first embodiment of the present invention, when a user requests the readout device to copy the copy-protected data file from the optical storage media, the data blocks and the overwrite modules of the copy-protected data file are simultaneously copied and downloaded to the readout device with codes of the overwrite modules being respectively interposed between codes of any two adjacent data blocks, such that the downloaded data file forms a non-readable error file, from which a bad faith user is not able to copy any data file from the optical storage media. The error file can be a garbled file, a bad track file, a wrong track file, or a format-changed file.

In the method of abolishing unauthorized copying of digital data on an optical disc according to a second preferred embodiment of the present invention, the copy protection module further includes a replication algorithm module for replicating the copy-protected data file when a bad faith user requests the readout device to copy the copy-protected data file from the optical storage media. The replication algorithm module is located between the data block and the overwrite module in one of the groups of data block and overwrite module of the copy-protected data file, and includes a replication module for repeatedly replicating the copy-protected data file and a skip module located in front of the replication module for skipping the replication by the replication module.

The skip module will cause the readout device to skip over the replication module when a user simply requests to read the data file from the optical storage media, and the readout device will repeat the procedure of reading the data blocks into the specified register and covering any previous data blocks therein. Therefore, a bad faith user is abolished from copying the data file from the specified register of the readout device.

On the other hand, the skip module does not execute any action when a bad faith user requests the readout device to copy the data file from the optical storage media, and the replication algorithm module of the copy-protected data file will repeatedly replicate the data blocks and the overwrite modules of the entire copy-protected data file to create an enormous data file, of which the copying just could not be completed by the bad faith user at all.

In both of the first and second embodiments, the data blocks of the data file and the overwrite modules of the copy protection module can be identical in file size, so that the data blocks and the overwrite modules of the copy-protected data file arranged in the optical storage media all appear to have the same length. However, with the data blocks and the overwrite modules arranged in the optical storage media in identical file size, a bad faith user can easily picked up and skipped over the copy protection module and crack this method of abolishing unauthorized copying of digital data stored on an optical disc.

Therefore, the data blocks of the data file and the overwrite modules of the copy protection module can be set to two different file sizes, so that the data blocks and the overwrite modules of the copy-protected data file arranged in the optical storage media have irregular lengths. By alternately arranging data blocks and overwrite modules to different file sizes, it shall greatly improve the effect of copy protection because a bad faith user can hardly picking up and evading the copy protection module in the optical storage media.

According to the method of the present invention, the copy-protected data file can be further encrypted using an encryption algorithm. The encryption algorithm includes the procedures of providing a media key in the optical storage media and a hardware device having a device key that could not be read out from an external environment; and combining the media key with the device key for data decryption, so that the whole process of data decryption is independently computed and completed all within the hardware device.

To implement the above-mentioned encryption algorithm, the file data stored on the optical storage media includes a media key block and a encrypted content block, and the device key embedded in the hardware device and the media key stored on the optical storage media are combined and computed to provide an encrypted decryption key, which is required for decrypting the encrypted content block.

According to another embodiment thereof, the encryption algorithm includes the procedures of encrypting and scrambling the optical storage media and using a hardware device to decrypt and descramble the optical storage media. To implement this encryption algorithm, the file data stored on the optical storage media includes an encrypted content created using a media key, a system timestamp generated from a device key, and an executable code generated through combination of an execution machine code with an encryption and scrambling procedure; and the hardware device performs the decryption and descrambling procedure using the device key, which is embedded in the hardware device, along with the executable code and the system timestamp stored in the optical storage media.

With the above arrangements, the method of the present invention for abolishing unauthorized copying of digital data stored on an optical disc provides the following advantages: any data file that is temporarily held in a specified register in a readout device is covered (overwritten) and deleted; a data file stored on an optical storage media will become an error file or an enormous data file when a bad faith user intends to illicitly copy any data file from the optical storage media, and the bad faith user can only obtain a useless data file or just could not complete the copying on a computer system when trying to copy the optical storage media, so that the data file stored on an optical storage media is protected against unauthorized copy and piracy to achieve the purpose of effectively protecting an inventor's intellectual property; and, the copy-protected data file established using the method of the present invention and stored on the optical storage media can be further protected by re-compiling it using an encryption algorithm. Therefore, the present invention provides enhanced efficacy in deterring unauthorized copying of an optical storage media by combining multiple different copy protection and anti-piracy techniques.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein

FIG. 1 is a conceptual diagram showing a method of abolishing unauthorized copying of digital data stored on an optical disc according to a first preferred embodiment of the present invention;

FIG. 2 is a structural block diagram of a copy-protected data file established and stored on an optical storage media according to the method of FIG. 1;

FIG. 3 is a procedural diagram showing how the copy-protected data file of FIG. 2 is run according to the method of FIG. 1;

FIG. 4 is a conceptual diagram showing how the copy-protected data file of FIG. 2 is downloaded from the optical storage media according to the method of FIG. 1;

FIG. 5 is a structural block diagram showing a method of abolishing unauthorized copying of digital data stored on an optical disc according to a second preferred embodiment of the present invention;

FIG. 6 is a procedural diagram showing a copy-protected data file established and stored on an optical storage media according to the method of FIG. 5 and how the copy-protected data file is executed when being read;

FIG. 7 is a procedural diagram showing how the copy-protected data file of FIG. 5 is executed when being copied;

FIG. 8 is a conceptual diagram showing the copy-protected data file established according to the method of the present invention including data blocks and overwrite modules of irregular lengths;

FIG. 9 is a conceptual diagram showing the copy-protected data file established according to the method of the present invention is encrypted with an encryption algorithm;

FIG. 10 is a conceptual diagram showing a first embodiment of the encryption algorithm according to the present invention;

FIG. 11 is a block diagram of the encryption algorithm shown in FIG. 10;

FIG. 12 is a conceptual diagram showing a second embodiment of the encryption algorithm according to the present invention; and

FIG. 13 is a block diagram of the encryption algorithm shown in FIG. 12.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

The present invention provides a method of abolishing unauthorized copying of digital data stored on an optical disc. With this method, a data file temporarily held in a specified register in a readout device is covered and deleted after it has been read and executed, so that a bad faith user could not pirate or illicitly copy the data file stored on the optical storage media via the register.

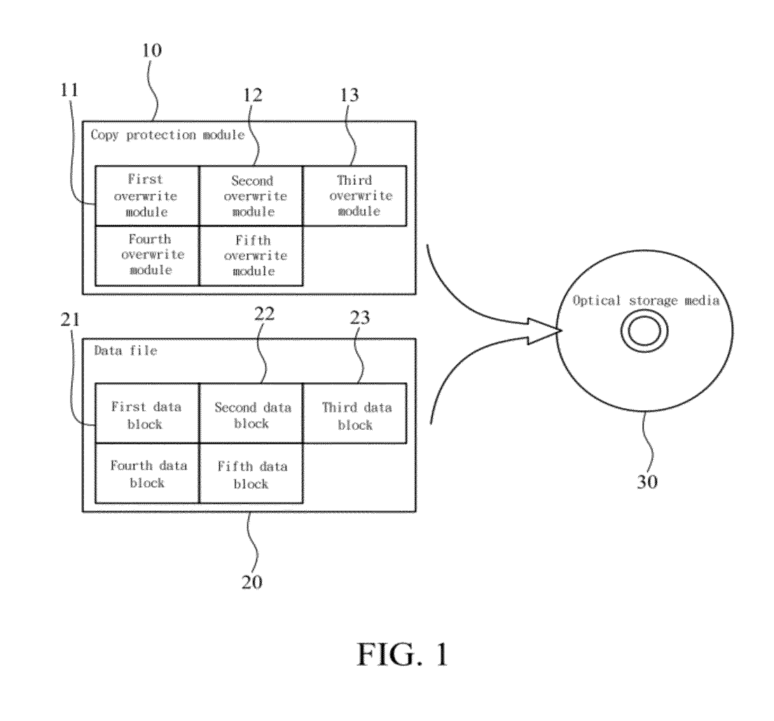

Please refer to FIG. 1 that shows a method of abolishing unauthorized copying of digital data stored on an optical disc according to a first preferred embodiment of the present invention. According to the method of FIG. 1, a copy protection module 10 is set up first. The copy protection module 10 internally includes a plurality of overwrite modules, which are distributed into a data file 20 to be protected, so that a copy-protected data file is created. Then, the copy-protected data file is written into an optical storage media 30. According to a preferred embodiment, the optical storage media 30 is preferably a non-rewriteable optical storage media.

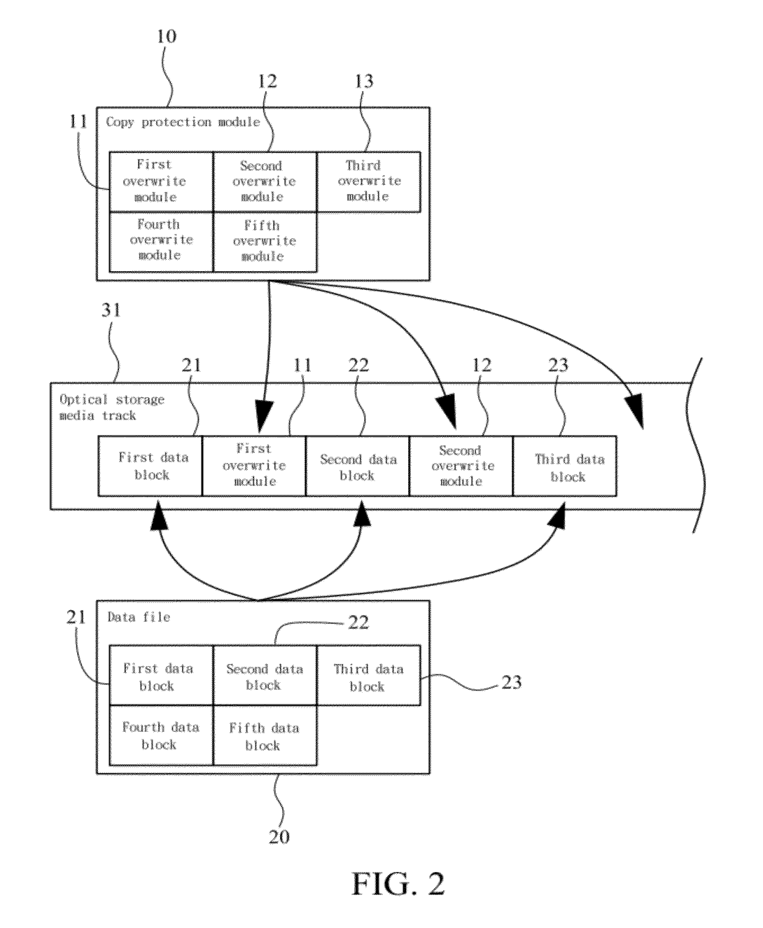

Please refer to FIG. 2. The copy-protected data file is created mainly by dividing the data file 20 into a plurality of data blocks; and distributing the overwrite modules of the copy protection module 10 into the data file 20, so that the overwrite modules are respectively interposed between two adjacent data blocks of the data file 20 and each data block and a following overwrite module together to form a group. The created copy-protected data file is then recorded onto an optical storage media track 31 with a first data block 21 and a first overwrite module 11 in a first group, a second block 22 and a second overwrite module 12 in a second group, a third data block 23 and a third overwrite module 13 in a third group, etc. sequentially arranged on along an optical storage media track 31.

In the preferred embodiment illustrated in FIG. 2, only three data blocks, namely, the first, second and third data blocks 21, 22, 23, and three overwrite modules, namely, the first, second and third overwrite modules 11, 12, 13, are shown for convenient description of the present invention. However, it is understood the illustrated preferred embodiment is not intended to limit the number of the data blocks and the overwrite modules to three in any way. That is, the number of the data blocks and the overwrite modules can be determined according to an actual size of the whole data file to be protected or a desired size of the divided data blocks. Therefore, it is also possible to have a fourth group of overwrite module and data block, or even have five or more groups of overwrite module and data block.

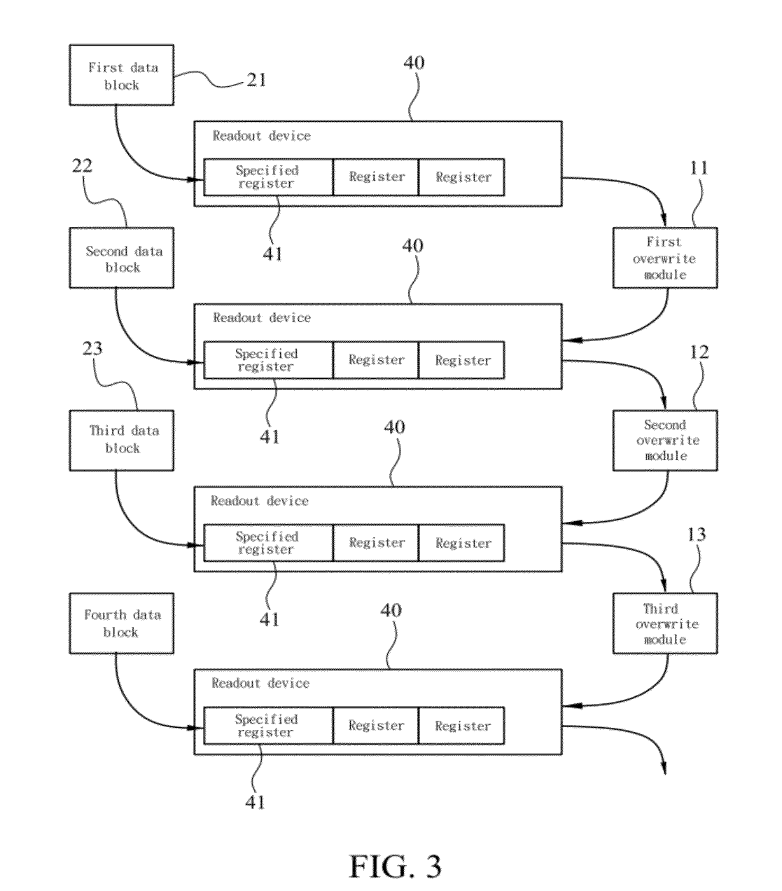

Please refer to FIG. 3. When a user puts the optical storage media 30 in a readout device 40 and requests the readout device 40 to read out the copy-protected data file from the optical storage media 30, the readout device 40 will first read the first data block 21 of the copy-protected data file into a specified register 41 for decoding. The readout device 40 will then read the first overwrite module 11. At this point, the first overwrite module 11 will request the readout device 40 to read the second data block 22 into the same specified register 41 to thereby cover the first data block 21. Since the readout device 40 continuously repeats the reading of subsequent data blocks, and the data blocks previously held in the specified register 41 are continuously covered by the subsequent data blocks being read into the specified register 41, no data of the data file 20, which is to be protected against unauthorized copying, would be held in the specified register 41 of the readout device 40.

For the purpose of the present invention, the expression “covered” means the data content previously read into and held in the specified register 41 is completely deleted from the register 41 and could not be recreated using any recovery program or device. Therefore, a hacker has no way to find any data temporarily held in the register and an inventor's intellectual property is effectively protected against unauthorized copying. The register can be a memory element but is not particularly limited thereto. In other words, the register can also be any other storage elements that provide a data storage function.

According to the method of the present invention, the data file 20 is divided into a plurality of data blocks to be read block by block and overwrite modules are interposed among the data blocks to enable covering of each previously executed data block, so that the readout device 40 reads the data file 20 block by block into the same specified register 41 for playing. Since the overwrite modules respectively interposed between any two adjacent data blocks have very short processing time, a user, due to persistence of vision, would not perceive the existence of the overwrite modules but feel seamlessly all the data blocks just like a data file 20 being executed continuously.

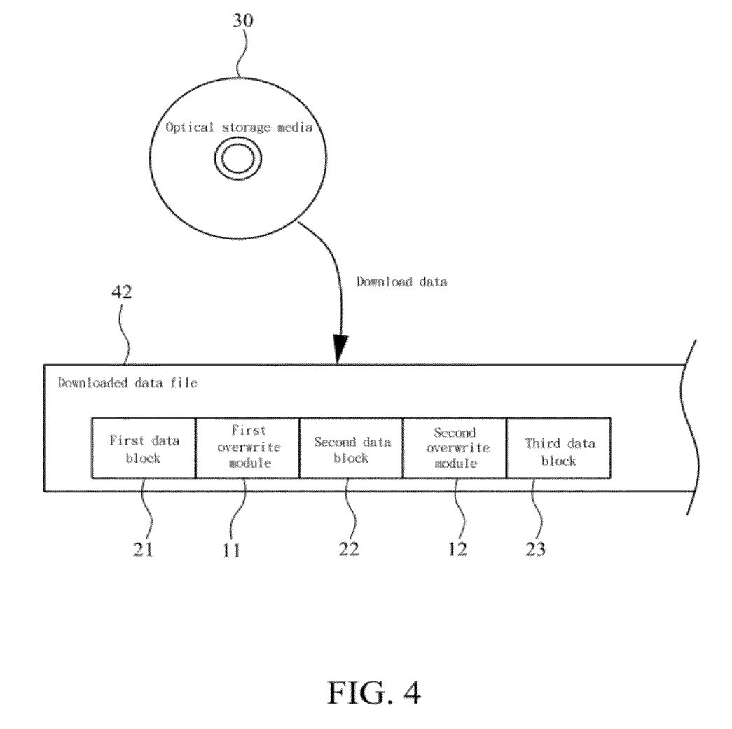

Please refer to FIG. 4. When a bad faith user requests for copying the copy-protected data file from the optical storage media 30, the readout device 40 will simultaneously copy and download the data blocks and the overwrite modules of the copy-protected data file to obtain a downloaded data file 42 with codes of the overwrite modules interposed among codes of the data blocks. As a result, the whole downloaded data file 42 is transformed as a non-readable error file. That is, the bad faith user can only get a useless downloaded data file 42 and could not access the copy-protected data stored in the optical storage media 30.

In an operable embodiment of the present invention, the error file may be a text garbled file, a bad track file, a wrong track file or a format-changed file. However, it is understood the above mentioned file types are illustrated only for convenient description of the present invention and not intended in any way to limit the forms of error files that can be used to abolish a bad faith user from copying the copy-protected data files.

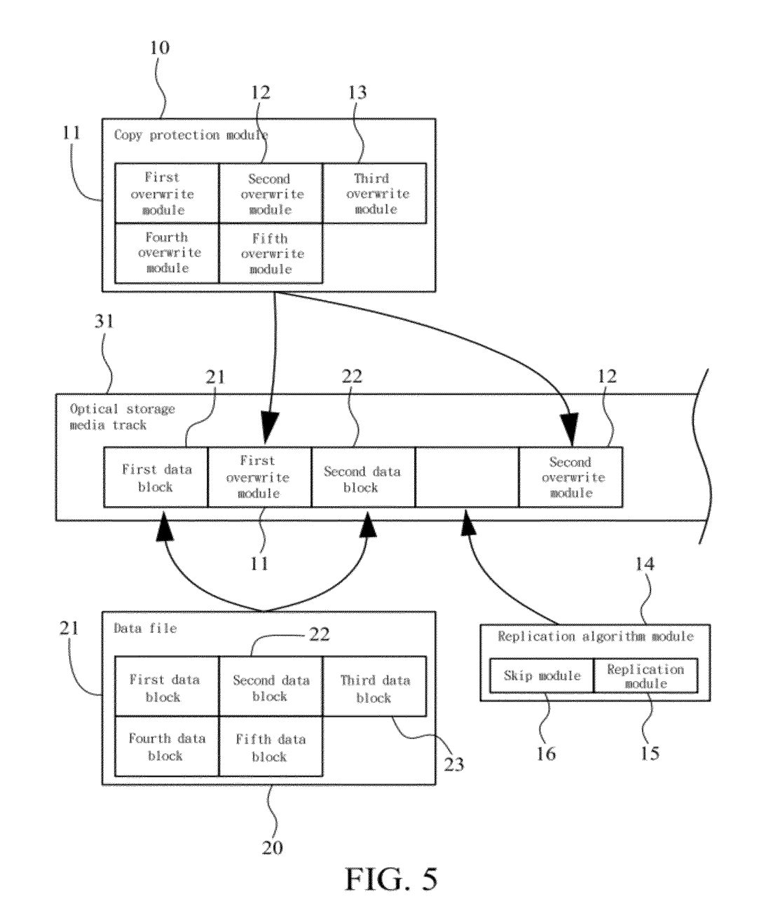

FIG. 5 is a structural block diagram showing a method of abolishing unauthorized copying of digital data stored on an optical disc according to a second preferred embodiment of the present invention. In the second embodiment, a copy protection module 10 similarly includes a plurality of overwrite modules, which are distributed into a data file 20. The second embodiment is different from the first embodiment in that the copy protection module 10 further includes a replication algorithm module 14.

The replication algorithm module 14 is located between a data block and an overwrite module in one of the groups, and includes a replication module 15 and a skip module 16. The replication module 15 functions to repeatedly replicate the copy-protected data file, and the skip module 16 is located in front of the replication module 15 and functions to skip the replication of the replication module 15.

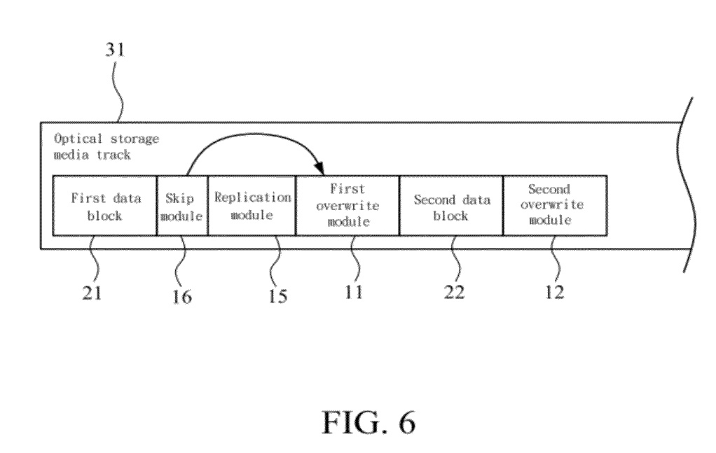

FIG. 6 is a procedural diagram showing a copy-protected data file established and stored on an optical storage media using the method of FIG. 5 and how the copy-protected data file is executed when being read. Please refer to FIG. 6. In the event a user simply requests the readout device 40 to read out the data file 20 from the optical storage media 30, the replication algorithm module 14 in the copy-protected data file will execute the skip module 16 to skip the replication module 15, so that the readout device 40 directly reads the overwrite module next to the replication module 15 to cover the previously executed data block, allowing the specified register 41 to repeatedly read in and overwrite the data blocks of the data file 20. With these arrangements, it is also possible to abolish a bad faith user from getting any data file via the specified register 41 of the readout device 40.

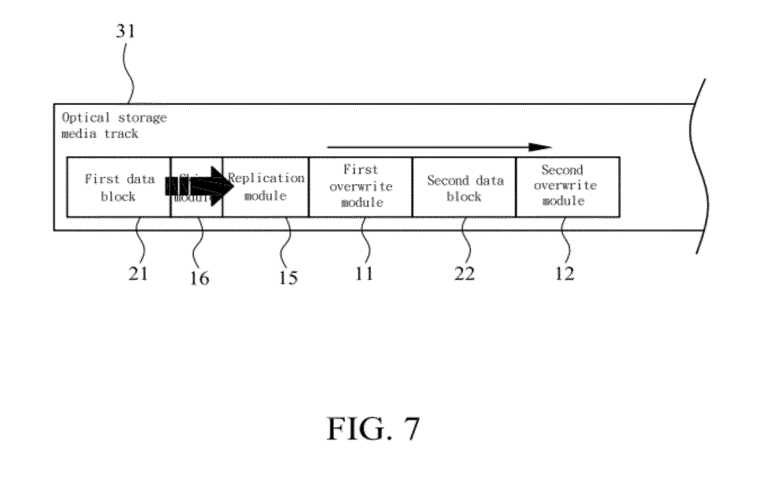

FIG. 7 is a procedural diagram showing how the copy-protected data file of FIG. 5 is executed when being copied. Please refer to FIG. 7. When a user requests the readout device 40 to copy the copy-protected data file of FIG. 5, the skip module 16 of the replication algorithm module 14 will not be executed. Instead, the readout device 40 will read in the replication module 15 of the copy-protected data file to thereby repeatedly replicate the data blocks and the overwrite modules of the whole copy-protected data file, bringing the downloaded copy-protected data file to infinitely expand and form an enormous data file, of which the copying just could not be completed at all.

For example, the time needed to copy the whole copy-protected data file as shown on a computer system might be various from a few minutes, which is usually needed to copy a data file of the original size, into several days or even several months when the downloaded data file is expanded into an enormous data file, so that a bad faith user could not complete the copying of the copy-protected data file at all.

Under this circumstance, the bad faith user is forced to abandon the intention of illegally copying the copy-protected data file. When the bad faith user exits or cancels the copying of the optical storage media 30, the replication algorithm module 14 shall terminate the replication without causing damage to the software and/or hardware of the computer system for the whole copy protection process.

In the first and second preferred embodiments of the present invention, the data blocks of the data file 20 and the overwrite modules of the copy protection module 10 can be identical in file size, so that the data blocks and the overwrite modules are alternately arranged on along the optical storage media track 31 and all appear a regular length. However, with the data blocks and overwrite modules of regular length alternately arranged on along the optical storage media track 31, a bad faith user can easily pick out and skip the copy protection module 10 to crack the copy protection technique provided by the method of the present invention.

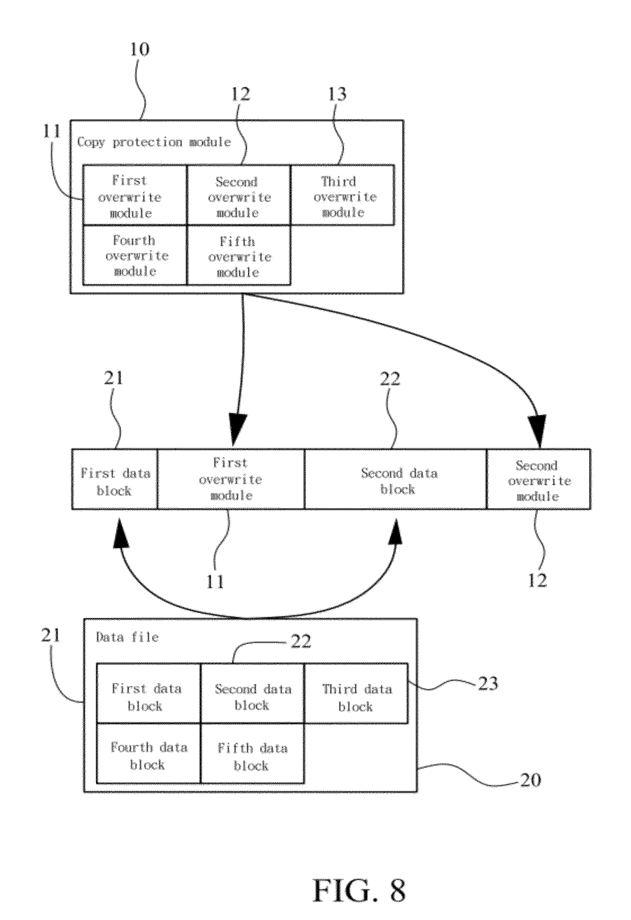

Therefore, please refer to FIG. 8, the data blocks of the data file 20 and the overwrite modules of the copy protection module 10 can be set to have different file sizes from one another, so that the data blocks and the overwrite modules of the copy-protected data file alternately arranged on along the optical storage media track have irregular lengths. By alternately arranging file data of different sizes on along the optical storage media track, it is possible to abolish the bad faith user from easily picking out and evading the copy protection module 10 in the optical storage media 30 to thereby largely enhance the efficacy of the method of the present invention for abolishing unauthorized copying of digital data stored on an optical disc.

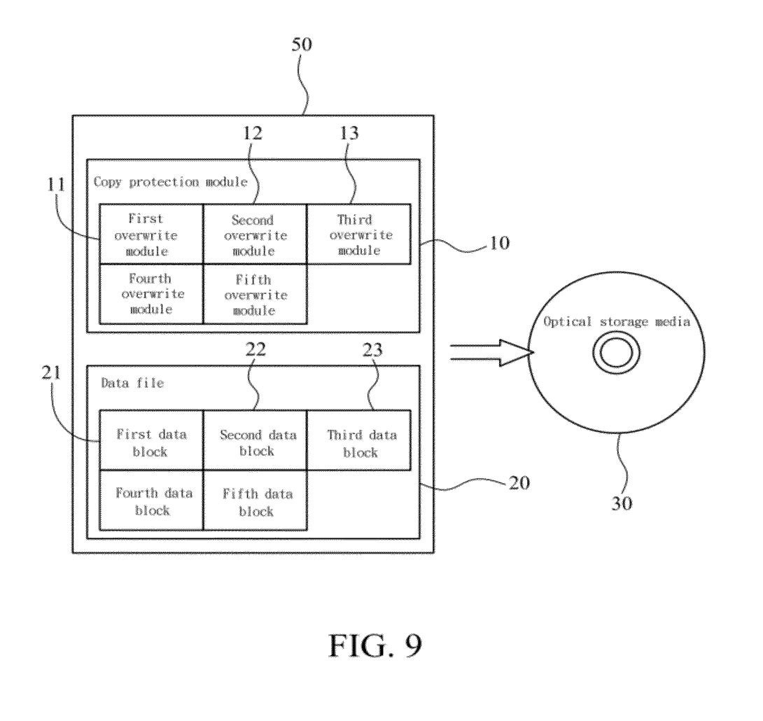

FIG. 9 is a conceptual diagram showing the copy-protected data file established according to the method of the present invention can be encrypted with an encryption algorithm 50 before being written into an optical storage media 30. Again, the optical storage media 30 is preferably a non-rewriteable optical storage media.

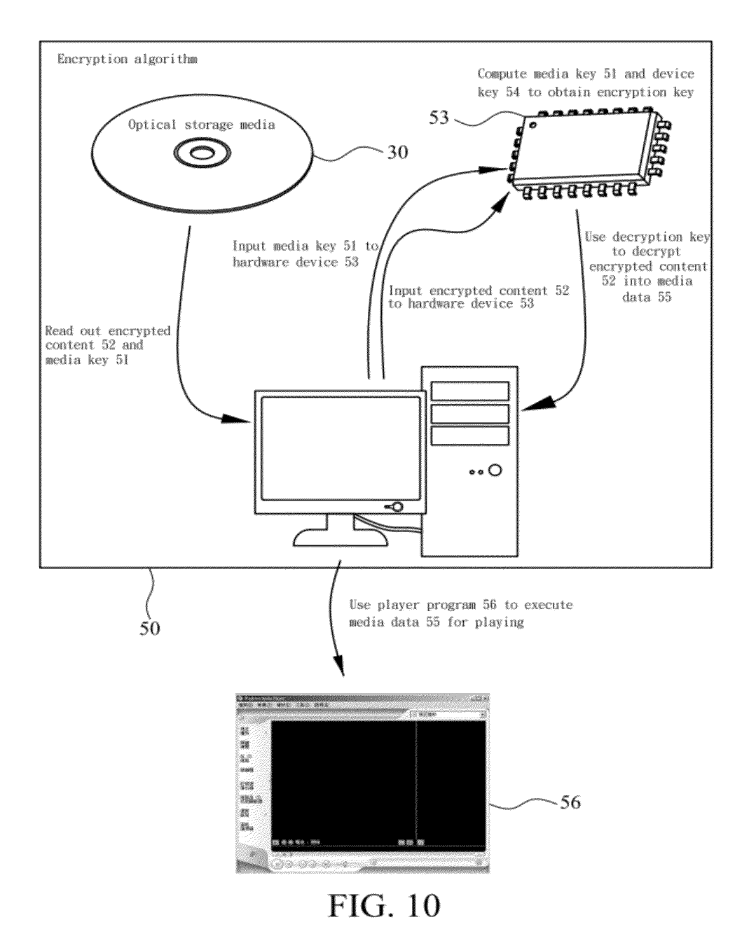

FIG. 10 is a conceptual diagram showing a first embodiment of the encryption algorithm 50 according to the present invention. In the first embodiment, the encryption algorithm 50 includes the procedure of providing a media key 51 in the optical storage media 30, and a hardware device 53 having a device key 54 that could not be read out from an external environment, and combining the media key 51 with the device key 54 to form a decryption key in the hardware device 53 for media data decryption, so that the whole process of data decryption is independently computed and completed all in the hardware device 53 and information about the keys is protected against scanning and piracy in the data decryption process.

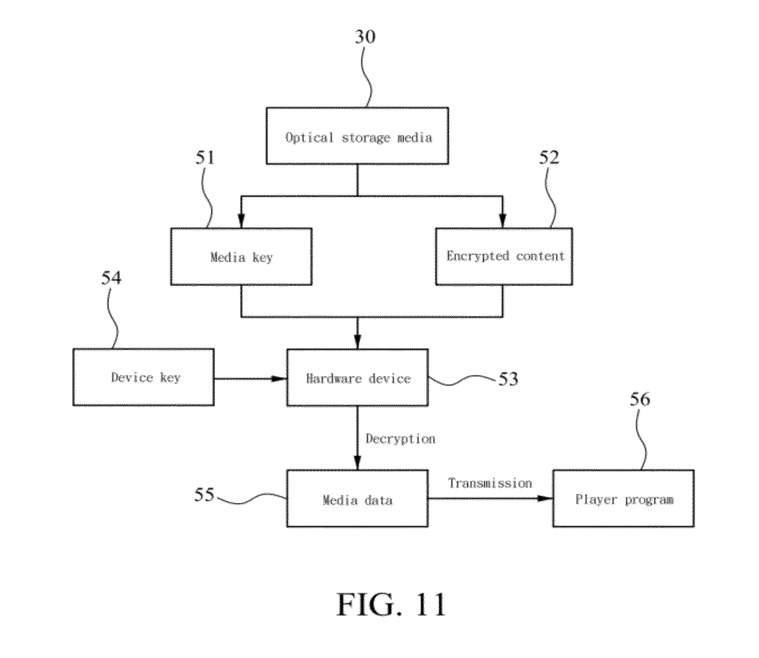

FIG. 11 is a block diagram of the encryption algorithm 50 according to the first embodiment thereof. As shown, the file data in the optical storage media 30 includes two parts, namely, a media key 51 and an encrypted content 52. A decryption key is required to decrypt the encrypted content 52. The decryption key is generated through combination of and computation on a device key 54 embedded in a hardware device 53 and the media key 51 stored on the optical storage media 30. Finally, the decryption key is used to decrypt the encrypted content 52 into a media data 55, which can be then directly executed by a player program 56 for playing.

Thus, the encryption algorithm 50 according to the first embodiment thereof is technically characterized in that, to decrypt the optical storage media 30, the hardware device 53 must first obtain the media key 51 and computes the media key 51 along with the device key 54 stored in the hardware device 53 with a correct algorithm to finally obtain the decryption key.

It is noted the device key 54 stored in the hardware device 53 could not be read out alone. Therefore, when a user intends to read out the encrypted media data from the optical storage media 30 via a computer system, the computer system must have the hardware device 53 assembled thereto and work together with the hardware device 53 to enable data decryption.

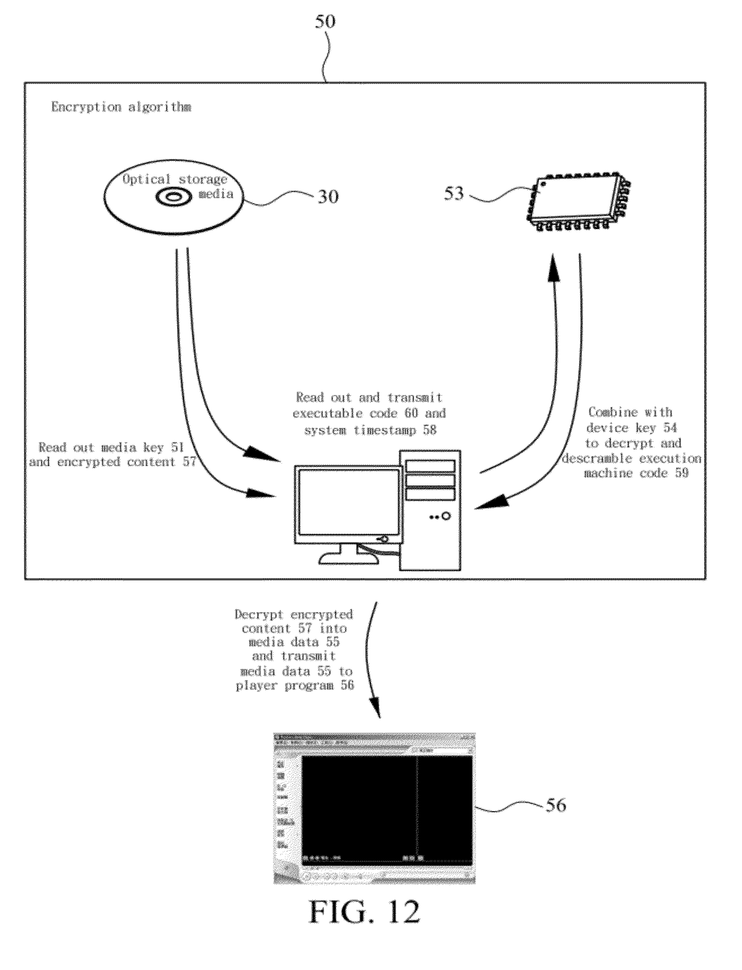

FIG. 12 is a conceptual diagram showing a second embodiment of the encryption algorithm 50 according to the present invention. In the second embodiment, the encryption algorithm 50 requires two parts, namely, the encryption and scrambling of an optical storage media 30 and the decryption and descrambling of the optical storage media 30 using a hardware device 53.

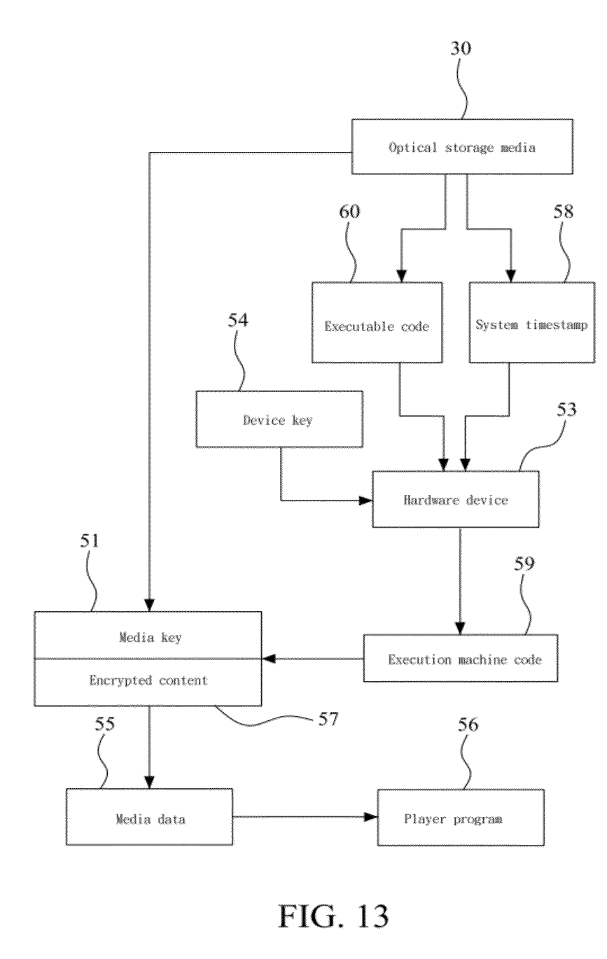

FIG. 13 is a block diagram of the encryption algorithm 50 according to the second embodiment thereof. As shown, the optical storage media 30 internally includes an encrypted content 57 created using a media key 51, a system timestamp 58 generated from a device key 54, and an executable code 60 generated through combination of an execution machine code 59 with an encryption and scrambling sequence. And, the hardware device 53 performs decryption and descrambling procedure using the device key 54 set up in the hardware device 53 along with the executable code 60 and the system timestamp 58 stored in the optical storage media 30.

Since the executable code 60 is generated by encrypting and scrambling the execution machine code 59 via the device key 54, the executable code 60 would not have any effect if it is executed alone. That is, the device key 54 of the hardware device 53 must be used together with the executable code 60 to decrypt and descramble the executable code 60 into the execution machine code 59, so that the computer system can use the execution machine code 59 to decrypt the encrypted content 57 stored on the optical storage media 30 for the encrypted content 57 to convert into a media data 55, which can be then directly executed by a player program 56 for playing.

From the above description, it is understood the encryption algorithm 50 according to the second embodiment thereof is technically characterized in the use of the hardware device 53 to encrypt and scramble as well as to decrypt and descramble the data stored on the optical storage media 30.

While the encryption algorithm 50 of the present invention is described with the above two embodiments, it is understood these embodiments are described only for the purpose of convenient explanation of the present invention and not intended to limit the types of encryption algorithm that can be used in the present invention. For example, the encryption algorithm 50 can also be the existing Sony-developed AACS copy-protection technique or use other additional encryption and copy-protection techniques to achieve good copy protection results from combination of multiple copy-protection measures.

In summary, according to the method of the present invention for abolishing unauthorized copying of digital data stored on an optical disc, a data file being read into and temporarily held in a specified register in a readout device will finally be covered (overwritten) and deleted, and a data file stored on an optical storage media being downloaded will form an error file or an enormous data file when a bad faith user intends to illicitly copy the data file from the optical storage media. In this respect, the bad faith user can only obtain useless file data or just could not complete the copying procedure on a computer system when trying to copy the optical storage media. That is, with the method of the present invention, a data file stored on an optical storage media is protected against piracy and unauthorized copying to achieve the purpose of effectively protecting an inventor's intellectual property.

In addition, the copy-protected data files established according to the method of the present invention and stored on the optical storage media can be further protected by re-compiling them using an encryption algorithm. Therefore, the present invention provides upgraded and enhanced effect in deterring unauthorized copying of an optical storage media through combination of multiple different copy protection and anti-piracy techniques.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of abolishing unauthorized copying of digital data stored on an optical disc, comprising the steps of distributing a plurality of overwrite modules of a copy protection module into a data file that is to be protected against illegal copying, so as to form a copy-protected data file; and writing the copy-protected data file into a non-rewriteable optical storage media;
wherein the overwrite modules of the copy protection module distributed into the data file are respectively arranged between any two adjacent data blocks of the data file, such that each data block and a following overwrite module together form a group and the copy-protected data file so formed includes a plurality of sequentially arranged first, second, third and more groups of data block and overwrite module; and
wherein, when a user requests a readout device to read out the copy-protected data file stored on the optical storage media, the readout device first reads the data block of the copy-protected data file in the first group into a specified register in the readout device for decoding, and then reads the overwrite module in the first group, which requests the readout device to read the data block in the second group into the same specified register to thereby cover the first data block having been read into the specified register; and the readout device repeatedly reads out subsequent data blocks into the specified register one by one while covering preceding data blocks temporarily held in the specified register, so that no data of the copy-protected data file is stored in the specified register of the readout device.

2. The method of abolishing unauthorized copying of ditigal data stored on an optical disc as claimed in claim 1, wherein, when a user requests the readout device to copy the copy-protected data file from the optical storage media, the data blocks and the overwrite modules of the copy-protected data file are simultaneously copied and downloaded to the readout device with codes of the overwrite modules being respectively interposed between codes of any two adjacent data blocks, such that the downloaded data file forms a non-readable error file.

3. The method of abolishing unauthorized copying of digital data stored on an optical disc as claimed in claim 2, wherein the error file is selected from the group consisting of a garbled file, a bad track file, a wrong track file, and a format changed file.

4. The method of abolishing unauthorized copying of digital data stored on an optical disc as claimed in claim 1, wherein the data blocks of the data file and the overwrite modules of the copy protection module are identical in file size, so that the data blocks and the overwrite modules of the copy-protected data file arranged in the optical storage media all have a regular length.

5. The method of abolishing unauthorized copying of digital data stored on an optical disc as claimed in claim 1, wherein the data blocks of the data file and the overwrite modules of the copy protection module are different in file size, so that the data blocks and the overwrite modules of the copy-protected data file arranged in the optical storage media have irregular lengths.

6. The method of abolishing unauthorized copying of digital data stored on an optical disc as claimed in claim 1, wherein the copy protection module further includes a replication algorithm module, which repeatedly replicates the copy-protected data file when a user requests the readout device to copy the copy-protected data file from the optical storage media.

7. The method of abolishing unauthorized copying of digital data stored on an optical disc as claimed in claim 6, wherein the replication algorithm module is located between the data block and overwrite module in one of the groups of data block and overwrite module of the copy-protected data file, and includes a replication module for repeatedly replicating the copy-protected data file and a skip module located in front of the replication module for skipping the replication by the replication module.

8. The method of abolishing unauthorized copying of digital data stored on an optical disc as claimed in claim 7, wherein the skip module causes the readout device to skip over the replication module when a user simply requests the readout device to read out the data file from the optical storage media, and the data blocks are sequentially read into the specified register by the readout device while covering the data blocks previously read into the specified register.

9. The method of abolishing unauthorized copying of digital data stored on an optical disc as claimed in claim 7, wherein the skip module does not execute any action when a user requests the readout device to copy the data file from the optical storage media, and the replication module of the copy-protected data file repeatedly replicates the data blocks and the overwrite modules of the whole copy-protected data file to thereby create an enormous dat file, of which the copying just could not be completed at all.

10. The method of abolishing unauthorized copying of digital data stored on an optical disc as claimed in claim 1, wherein the copy-protected data file is further encrypted using an encryption algorithm.

11. The method of abolishing unauthorized copying of digital data stored on an optical disc as claimed in claim 10, wherein the encryption algorithm includes the procedures of providing a media key in the optical storage media and a hardware device having a device key that could not be read from an external environment; and combining the media key and the device key for data decryption, so that a whole process of the data decryption is independently computed and completed all in the hardware device.

12. The method of abolishing unauthorized copying of digital data stored on an optical disc as claimed in claim 11, wherein the optical storage media internally includes a media key block and a encrypted content block; and the device key embedded in the hardware device and the media key stored on the optical storage media are combined and computed to obtain an encrypted decryption key, which is required for decrypting the encrypted content block.

13. The method of abolishing unauthorized copying of digital data stored on an optical disc as claimed in claim 10, wherein the encryption algorithm includes the procedures of encrypting and scrambling the optical storage media and using a hardware device to decrypt and descramble the optical storage media; the optical storage media internally including an encrypted content created using a media key, a system timestamp generated from a device key, and an executable code generated through combination of an execution machine code with an encryption and scrambling sequence; and the hardware device performing the decryption and descrambling procedure using the device key, which is set up in the hardware device, along with the executable code and the system timestamp stored in the optical storage media.
